(19) United States
(12) Patent Application Publication
(10) Pub. No.: US 2015/0236918 A1
(43) Pub. Date: Aug. 20, 2015

(54) METHOD AND SYSTEM FOR CREATING SINGLE SNMP TABLE FOR MULTIPLE OPENFLOW TABLES

(71) Applicants: Senthil Gurusamy CS, Chennai (IN); Rajesh Kidambi, Chennai (IN)

(72) Inventors: Senthil Gurusamy CS, Chennai (IN); Rajesh Kidambi, Chennai (IN)

(73) Assignee: Aricent Holdings Luxembourg S.à.r.l, LUXEMBOURG, OT (unknown)

(21) Appl. No.: 14/181,626

(22) Filed: Feb. 15, 2014

(51) Int. Cl. H04L 12/24

(52) U.S. Cl. CPC H04L 41/12

(57) ABSTRACT

In Software-Defined Networking (SDN) architecture, OpenFlow tables are dynamic and are defined by user or controller. Simple Network Management Protocol (SNMP) provides information or status about tens or hundreds of managed devices. Traditional SNMP view displays each OpenFlow table one by one in text format. There is no consolidated view for administrator to look at OpenFlow tables. This invention provides system and method for consolidating dynamic OpenFlow tables into a single SNMP view. While displaying single view, OpenFlow table acts as index and is used to view multiple flow tables by iterating each row in flow table in SNMP.

### BACKGROUND

1. Field of the Invention

The present invention relates to network management using the Simple Network Management Protocol (SNMP) and, more particularly, to a method and system for creating and viewing single SNMP table for multiple openflow flow tables.

2. Description of the Related Art

The simple network management protocol (SNMP) is an Internet-standard protocol for managing devices on Internet protocol (IP) networks. Devices that typically support the SNMP include routers, switches, servers, workstations, printers, and modem racks, among other types of devices. The SNMP is primarily used in network management systems to monitor network-attached devices for conditions that warrant administrative attention. The SNMP exposes management data in the form of variables on managed systems, which describe the system configuration. These variables can then be queried, and sometimes set, by managing devices.

Using SNMP, network administrators can address queries and commands to network nodes and devices. SNMP monitors network performance and status; controls operational parameters; and reports, analyzes and isolates faults. The protocol accomplishes these functions by transporting management information between “Managers” and “Agents”. As shown in FIG. 1, SNMP defines the following three basic components:
Managed device
Agent—software which runs on managed devices
Network management system (NMS)—software which runs on the manager

A managed device is a network node that implements an SNMP interface that allows unidirectional (read-only) or bidirectional (read and write) access to node-specific information. Managed devices exchange node-specific information with the NMSs. Sometimes called network elements, the managed devices can be any type of device, including, but not limited to, routers, access servers, switches, bridges, hubs, IP telephones, IP video cameras, computer hosts, and printers.

A SNMP agent is a network-management software module that resides on a managed device. An agent has local knowledge of management information and translates that information to or from an SNMP-specific form.

A network management system (NMS) executes applications that monitor and control managed devices. NMSs provide the bulk of the processing and memory resources required for network management. One or more NMSs may exist on any managed network.

Today, OpenFlow provides protocols and a platform for monitoring the network, but it also provides a powerful toolset for configuring the network in a positively controlled system with multiple feedback loops for accuracy and confirmation. Not a single traditional network monitoring and management tool offers this capability. Our search at US and European Patent Database reveals several pending and issued patents relating to managing openflow tables.

U.S. Pat. No. 6,032,183 A is titled as System and method for maintaining tables in an SNMP agent. It offers is a new system that allows a Manager in a Simple Network Management Protocol (SNMP) environment to gather updates from its Agents. The system and method comprise the unique provision of an index which is used in each of the Agent's tables for indicating the various revisions thereof. The index lexicographically increases with each revision to the table. The Manager maintains a record of the index of the data which it has received from its Agents, requesting only that data having a lexicographically larger indexing. Further, the index is used in related tables so that the tables will be kept in “sync” in that the Manager will know whether it has the latest updates so that an accurate picture may be portrayed.

EP 0449438 A2, titled as “Graphical user interface management system and method” relates to graphical user interface management systems, and in particular, to those systems which enable management of user interfaces by means of tables of a relational type.

US 20130272135 A1 is titled as Traffic visibility in an open networking environment. This invention describes a method of monitoring network traffic includes accessing a network that includes a controller and a switch device having a flow table, wherein the controller is communicatively coupled to the switch device, and is configured to program a behavior of the switch device through an openflow protocol, and obtaining information regarding the programmed behavior of the switch device.

Though several attempts have been made to consolidate dynamic OpenFlow tables into a single SNMP view, there does not exists a consolidated view that enables administrator to efficiently look at OpenFlow tables to provide for single SNMP Table view for any number of openflow tables and also provide for single match field to hold any type of matching data.

### SUMMARY OF THE INVENTION

Other aspects, advantages, and salient features of the invention will become apparent to those skilled in the art from the following detailed description, which, taken in conjunction with the annexed drawings, disclose exemplary embodiments of the invention.

Embodiment of the present invention provides for creating and viewing single SNMP table for multiple openflow tables.

In one embodiment, a Single SNMP Table view is provided for any number of openflow flow tables.

In another embodiment, a single Match field is provided to hold any type of matching data i.e., it can hold MAC, IP, PORT, etc.

In yet another embodiment of the present invention, there is no need to redefine SNMP tables, if controller or user changes the number of flow tables and match fields.

In one more embodiment, we provide for an easy view for remote administration (single table to view and understand the flows).

In another embodiment, we can use this single SNMP table to view all the devices/contexts flow tables, even if the system supports multiple devices/contexts.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a SNMP model according to one or more embodiments of the present invention;

FIG. 2 depicts a typical OSI Layers;

FIG. 3 depicts a typical text for OpenFlow Individual Tables view

FIG. 4 depicts an OpenFlow and SNMP—Single View, according to one or more embodiments of the present invention.

FIG. 5 depicts an OpenFlow Individual flow Tables for Layers 1,2 and 3 devices, according to one or more embodiments of the present invention.

FIG. 6 depicts OpenFlow Single flow Table for Layers 2,3 and 4 devices, according to one or more embodiments of the present invention.

FIG. 7 depicts SNMP table details, according to one or more embodiments of the present invention.

### DETAILED DESCRIPTION

In the present description, some words are being used interchangeably to mean the same thing/entity: ‘Customers’ & ‘Users’; ‘He’ and “She”.

It is appreciated that present invention can be implemented in a variety of systems, devices, architectures and configurations. Embodiments described herein may be discussed in the general context of computer-executable instructions residing on some form of computer-readable storage medium, such as program modules, executed by one or more computers, computing devices, or other devices.

For explanation of this invention following terms and concepts are covered in brief:
Simple Network Management Protocol (SNMP)
Open Systems Interconnection (OSI) model
OpenFlow

### Simple Network Management Protocol (SNMP):

SNPM is an internet protocol for managing devices on IP (internet protocol) networks. The devices include routers, switches, servers, workstations, printers, modem and more.

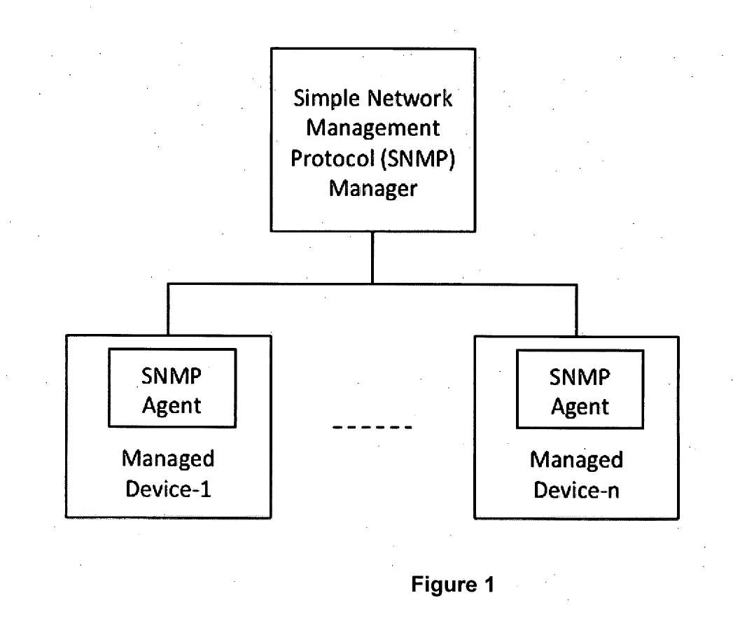

It comprises of following components (as shown in FIG. 1):
Managed Device—A managed device supports SNMP protocol beyond its normal functions.
Agent—process running on each managed device collecting information about the device it is running on. Agent passes on the collected information via SNMP to Manager.
Manager—process running on a management workstation that requests information about devices on the network.

This invention provides a method for creating and displaying single SNMP table.

### Open Systems Interconnection (OSI) Model

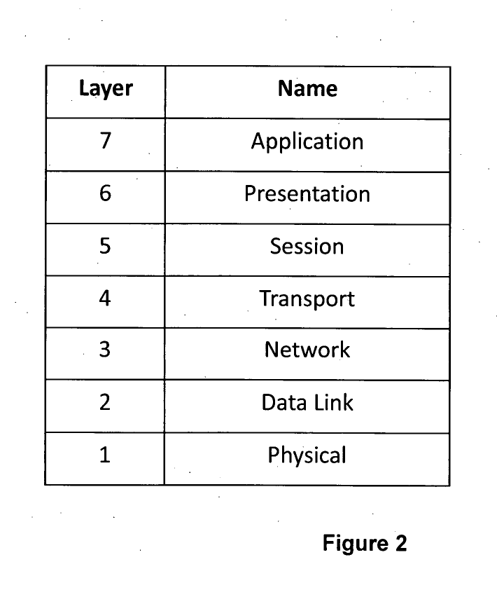

It comprises of seven layers shown as shown in FIG. 2. It is a conceptual model that characterizes and standardizes the internal functions of a communication system by partitioning it into abstraction layers. The model groups similar communication functions of a communication system into standard and abstract layers.

The model defines a networking framework to implement protocols in seven layers. Control is passed from one layer to the next, starting at the application layer in one station, and proceeding to the bottom layer, over the channel to the next station and back up the hierarchy.
Application (Layer 7): This layer supports application and end-user processes.
Presentation (Layer 6): This layer provides independence from differences in data representation (e.g., encryption) by translating from application to network format, and vice versa.
Session (Layer 5): This layer establishes, manages and terminates connections between applications.
Transport (Layer 4): This layer provides transparent transfer of data between end systems, or hosts, and is responsible for end-to-end error recovery and flow control. It ensures complete data transfer.
Network (Layer 3): This layer provides switching and routing technologies, creating logical paths, known as virtual circuits, for transmitting data from node to node.
Data Link (Layer 2): At this layer, data packets are encoded and decoded into bits.
Physical (Layer 1): This layer conveys the bit stream—electrical impulse, light or radio signal—through the network at the electrical and mechanical level.

At each level two entities at peer level interact with each other using defined protocol. For example, level-3 on a device will interact with its peer at level-3 through underlying levels and defined protocol. A layer serves the layer above it and is served by the layer below it. For example, Data Link layer serves Network layer. Network layer servers Transport layer.

From this inventions point of view, the devices for which consolidated table view is provided are in layer-1, layer-2 and layer-3.

### OpenFlow

The Software-Defined Networking (SDN) architecture decouples the network control plane from forwarding plane. The control plane controls several devices. This architecture enables network control to become directly programmable and the underlying infrastructure to be abstracted for applications and network services.

The OpenFlow protocol is a standard communications interface defined between the control and forwarding layers of an SDN architecture. In a classical router or switch, the fast packet forwarding (data path) and the high level routing decisions (control path) occur on the same device. An OpenFlow Switch separates these two functions. The data path portion still resides on the switch, while high-level routing decisions are moved to a separate controller, typically a standard server. The OpenFlow Switch and Controller communicate via the OpenFlow protocol, which defines messages, such as packet-received, send-packet-out, modify-forwarding-table, and get-stats.

OpenFlow allows direct access to and manipulation of the forwarding plane of network devices such as switches and routers, both physical and virtual (hypervisor-based). It can go well beyond the abilities of network monitoring or management tools by enabling a centralized view of the entire network configuration along with control even in a dynamic virtual environment.

The present invention provides single SNMP view of OpenFlow flow tables that are dynamically defined by user or controller.

### OpenFlow Flow Table Individual View:

Openflow flow table has multiple tables. Number of tables and elements in each table are dynamic. Hence, getting a SNMP table view for these tables is not possible.

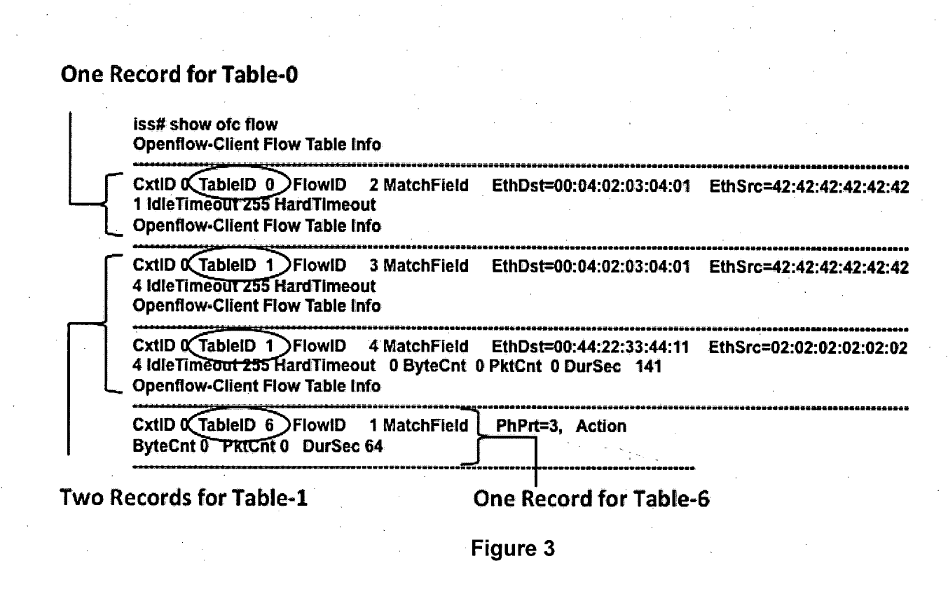

FIG. 3 shows how the individual OpenFlow tables are visible to the Administrator of the system. There is one row for table-1, two rows for table-2 and one row for table-6. The figure shows one device entry from TableId=0 and two entries from TableId=1 and one entry from TableId=6. Other relevant details including matching fields are shown in the same row. For example, TableID 0 has destination MAC shown by field EthDst=00:04:02:03:04:01. Typically there are tens or hundreds of devices. The tables will be shown row by row as a list.

This is not an efficient way for administrator to get over all view and the status of devices.

### OpenFlow Tables' Single SNMP Table View:

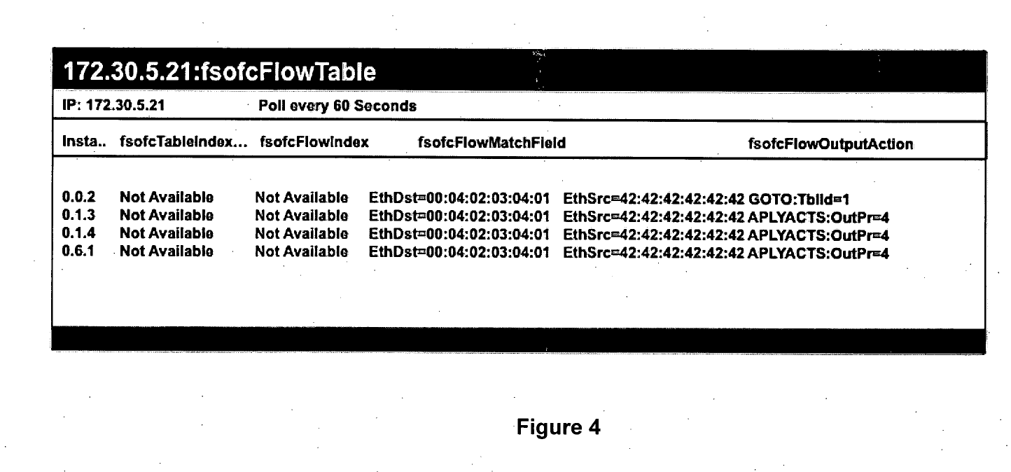

Based on the invention, we provide a single view of all tables and all elements as shown in FIG. 4. The tables are displayed as rows and the elements are displayed as columns.

The consolidated view in one-table shows following:
First column represents Device.Table.Entry hierarchy. Hence 0.0.2 displays the status of 2 entry in table 0 and device 0. Similarly second and third row with 0.1.3 and 0.1.4 entry show the status of 3 and 4 entries in table 1 and device 0.
There is one row for table-1, two rows for table-2 and one row for table-6.
The figure shows one device entry from TableId=0 and two entries from TableId=1 and one entry from TableId=6.
Other relevant details including matching fields are shown in the same row. For example, TableID 0 has destination MAC shown by field EthDst=00:04:02:03:04:01.

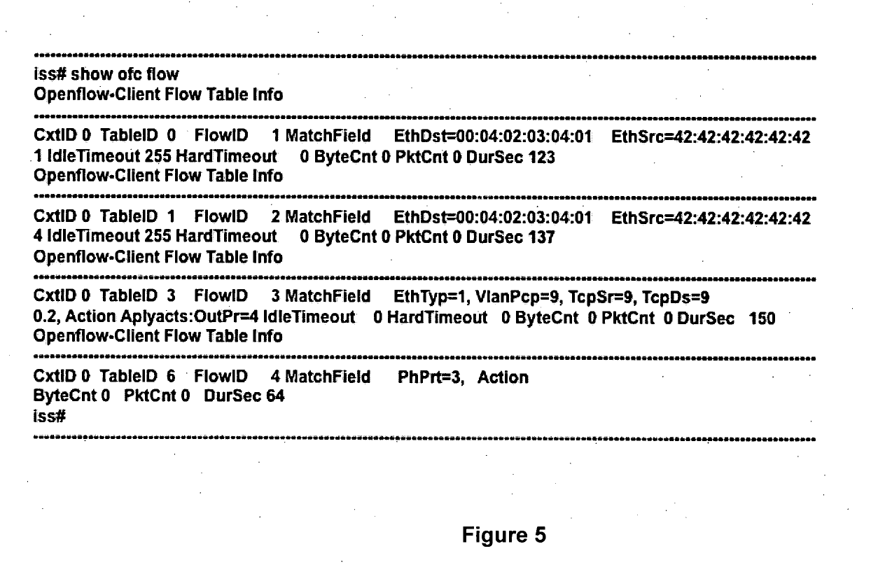

Now, let us consider how the table helps in identifying the devices at different levels. FIG. 5 shows the individual row view for device at each level. For example, the devices in row 1 and row 2 are same type. The devices in row 3 and row 4 are of different type. This is identified by analyzing value shown in 5^{th} Column.

Individual view of layer-2, layer-3 and layer-4 type tables are shown in FIG. 5. FIG. 4 is from the SNMP manager and FIG. 5 is local system console view. They both represent the same table only. One from SNMP manager and one from local console.

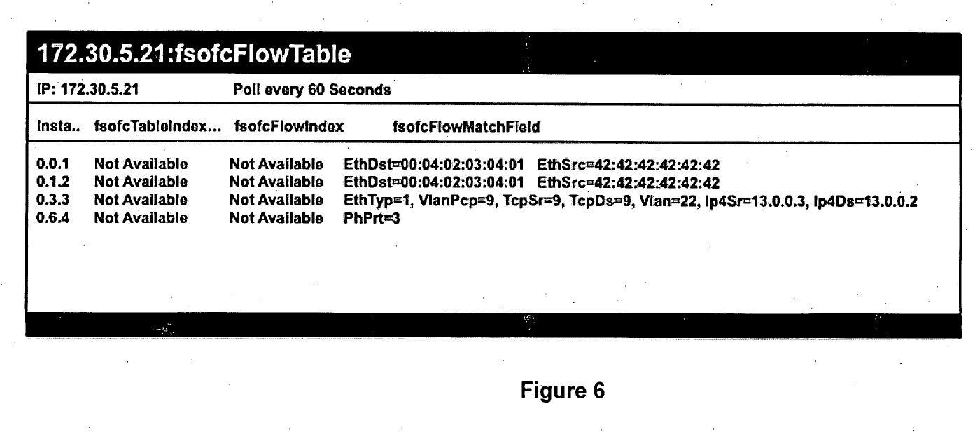

Based on the invention a single view of these tables is shown in FIG. 6.

Based on value in 4^{th} field the device is identified.
First two rows represent Layer-2 table based on their Ethernet Source and Ethernet Destination values.
Third row represents Layer-3 table based on IP Source and IP Destination value.
Fourth row represents Layer-4 table based on Layer-4 Protocol Port number values.

This is useful for OpenFlow enabled switches and remote monitoring of the OpenFlow switches from an SNMP manager on all flows installed in the switch.

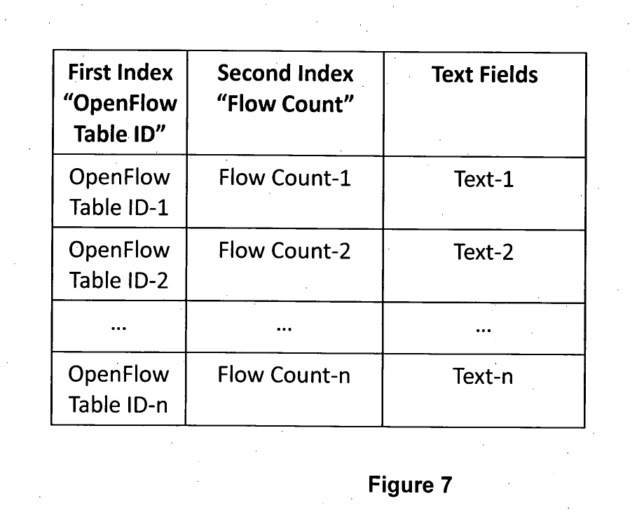

FIG. 7 depicts SNMP table details and the explanation of fields in row and column.

Steps: Following are the steps of implementation:
A flow table is defined in SNMP.
This table has device/context as first index
OpenFlow table id as second index.
Flow count is used as third index.

Each row represents entry for OpenFlow Table.

While displaying single view, OpenFlow table acts as index and is used to view multiple flow tables by iterating each row in flow table in SNMP.

As the index is to OpenFlow table, this invention addresses dynamic tables view using SNMP single table.

Another important aspect of the invention is that the elements are stored as String in columns in tables. Hence, it can hold IP Address, Mac address or port number. These are converted to correct format and displayed in single SNMP view.

While the foregoing is directed to embodiments of the present invention, other and further embodiments of the invention may be devised without departing from the basic scope thereof, and the scope thereof is determined by the claims that follow.

1. A method to create a single Simple Network Management Protocol (SNMP) table for multiple Openflow tables, comprising:
defining a flow table as in SNMP that has device/context as first Index:
generating a second index with OpenFlow table Ids; and
generating a third index with flow count,
wherein OpenFlow table acts as Index to view multiple flow tables by iterating each row in flow table in SNMP, to provide for a single view display, thus providing dynamic tables view using SNMP single table.

2. The method of claim 1, wherein a single view is provided for all tables and all elements being dynamically defined by the user or controller.

3. The method of claim 1, wherein the tables are displayed as rows and the elements are displayed as columns

4. The method of claim 3, wherein such elements are stored as string in columns in tables to hold IP Address, Mac address or the port number.

5. The method of claim 1, wherein the OpenFlow table addresses dynamic tables view using SNMP single table.

6. The method of claim 1, wherein the Openflow single table is created for layers 2,3 and 4, by further comprising the steps of:
defining required number of rows to represent Layer-2 table(s) based on their Ethernet Source and Ethernet Destination values.
defining required number of rows to represent Layer-3 table(s) based on IP Source and IP Destination value; and
defining required number of rows to present Layer-4 table(s) based on Layer-4 Protocol Port number values,
that enables remote monitoring of OpenFlow switches from an SNMP manager.

7. The method of claim 1, further comprising the consolidated view in one-table depicting,
first column to represent Device.Table.Entry hierarchy,
one row for table-1, two rows for table-2 and one row for table-6,
one device entry from TableId=0 and two entries from TableId=1 and one entry from TableId=6,
wherein other relevant details, including matching fields can be shown in the same row.

8. An apparatus to create a single Simple Network Management Protocol (SNMP) table for multiple Openflow tables, comprising:
first index with flow table as in SNMP that has device/context;
second index with OpenFlow table Ids; and
third index with flow count,
wherein such table acts as Index to view multiple flow tables by iterating each row in flow table in SNMP, to provide for a single view display, thus providing dynamic tables view using SNMP single table.

9. The apparatus of claim 8, wherein a single view is provided for all tables and all elements being dynamically defined by the user or controller.

10. The apparatus of claim 8, wherein the tables are displayed as rows and the elements are displayed as columns.

11. The apparatus of claim 10, wherein such elements are stored as string in columns in tables to hold IP Address, Mac address or the port number

12. The apparatus of claim 8, wherein the OpenFlow table addresses dynamic tables view using SNMP single table.

13. The apparatus of claim 8, wherein the OpenFlow single table is created for layers 2, 3 and 4 further comprising of;
the required number of rows to represent Layer-2 table based on their Ethernet Source and Ethernet Destination values.
required number of row to represent Layer-3 table based on IP Source and IP Destination value; and
required number of row to represent Layer-4 table based on Layer-4 Protocol Port number values,
that enables remote monitoring of OpenFlow switches from an SNMP manager.

14. The apparatus of claim 8, further comprising the consolidated view in one-table depicting,
one column to represent Device.Table.Entry hierarchy,
required number of row(s) correspond to the table(s) they represent
required number of device entries
wherein other relevant details, including matching fields can be shown in the same row.
